(19) United States
(12) Patent Application Publication
(10) Pub. No.: US 2021/0153493 A1
(43) Pub. Date: May 27, 2021

(54) LIGHT HAVING A FLY KILLING FUNCTION

(71) Applicants: Jian ZHANG, Nanjing (CN); Robert Bruce CAMERON, Buckeye, AZ (US)

(72) Inventors: Jian ZHANG, Nanjing (CN); Robert Bruce CAMERON, Buckeye, AZ (US)

(21) Appl. No.: 17/165,644

(22) Filed: Feb. 2, 2021

Related U.S. Application Data
(63) Continuation-in-part of application No. 15/392,306, filed on Dec. 28, 2016, now Pat. No. 10,905,111.
Application No. 15/392,306 is a continuation-in-part of application No. 29/727,886, filed on Mar. 13, 2020, now Pat. No. D909629.

(30) Foreign Application Priority Data
Nov. 3, 2016 (CN) 201610952015.7

(51) Int. Cl. A01M 1/08; F21V 23/00; F21V 3/02; F04D 27/00; F04D 29/62; F04D 29/70; F04D 17/16

(52) U.S. Cl. CPC A01M 1/08; F21V 23/001; F21V 3/02; F04D 27/00; F21Y 2115/10; F04D 29/703; F04D 17/16; A01M 2200/012; F04D 29/624

(57) ABSTRACT

The present disclosure relates to a light, in particular, to a light having a fly killing function that can be used for lighting and killing flies comprising at least one LED chip, a fly storage means, a negative pressure fan, a fan hanger, a ventilation net, and a power supply; wherein the fly storage means is connected to the fan hanger, the LED chip is secured to a lower end of the fly storage means, the fly storage means comprises an air inlet and a fly storage groove, the negative pressure fan is mounted onto the fan hanger above the fly storage means, a gap is provided between the blades of the negative pressure fan and an upper end of the fly storage means to allow flies to go through; the ventilation net comprises a plurality of ventilation holes having a size that is able to stop flies from passing therethrough, and the ventilation net is provided circumferentially between the outside wall of the fan hanger and the outside wall of the fly storage means, and the fan hanger, the ventilation net, and the fly storage means form a closed space except the ventilation holes and the air inlet.

### FIELD OF THE INVENTION

The present invention relates generally to a light. More specifically, the present invention relates to a light having a fly-killing or extermination function that can be used for both lighting and pest extermination.

### TECHNICAL BACKGROUND OF THE INVENTION

The present disclosure is generally directed to an effective black light, insect extermination device which takes advantage of flies and other insect behaviors, such as phototaxis and photokinesis, moving and flying with air flow, temperature sensitivity, gregariousness, and especially the olfactory and sensory behavior of following carbon dioxide emissions and sex pheromones. The fly-killing lamp typically does not use any fly-killing chemicals, and thus is an environmentally friendly and pollution-free way of killing flies.

Chinese Patent CN 201270731 Y discloses a photocatalysis fly killer comprising a shell having an upper opening, a fan fixed at the upper opening of the shell by a fixing holder, a ventilation filter screen provided at the side surface of the lower section of the shell; a titanium oxide coated plate is fixed above the shell by vertical posts; and a zapper lamp is provided above the titanium oxide coated plate and at the side of the coating layer. With the zapper lamp and the photocatalysis generated by a photocatalyst, the photocatalysis fly killer can simulate the situation of a human exhaling wet carbon dioxide wind, so as to induce flies to approach and draw them into the shell by a strong airflow generated by the fan, and then the flies are air-dried and dehydrated to death. This patent can be used merely as a fly-killing device, and a titanium oxide coated plate is required, which results in a complex structure.

Chinese Patent CN 201230527 Y discloses a fly killer which comprises a shell, a top cover, an ultraviolet tube, an air inlet, a fan, a fan support, and a fly storage means, wherein the air inlet is disposed between the top cover and the shell, the ultraviolet tube is disposed in the air inlet under the top cover, the fan is disposed in the shell under the air inlet and provided on the fan support, and the fly storage means is disposed under the fan support. The fan is a centrifugal fan. When the fan blades rotate, the airflow produced by the centrifugal fan is dispersed all around in the form of a vortex, and a vacuum is formed in the middle thereof, so that supplemental air from outside flows inside quickly. When air flows inside, flies are trapped, thereby achieving the effect of fly-killing. This patent uses an ultraviolet tube and cannot be used as a light.

Chinese patent CN203136859 U discloses a fly killer wherein an anti-fly escape plate is provided at the top opening of a fly storage box, and a funnel structure is formed downward from the center of the anti-fly escape plate; the funnel structure is formed by a plurality of arc-shaped bodies, and the cross section of each arc-shaped body is in the shape of a triangle with a wide bottom and a pointed top; a ventilation hole is formed between each two adjacent arc-shaped bodies. Additionally, a light emitting device and a negative pressure fan are provided above the anti-fly escape plate. When the fly killer is in use, the light emitting device emits light, and the negative pressure fan generates a suction force, so that flies approach the fly killer and are sucked inside the killer, and fall within the fly storage box due to the anti-fly escape plate and then dried to death. Since each ventilation hole is formed between two arc-shaped bodies, and the wind resistance of the arc-shaped bodies are small, the air flow generated by the negative pressure fan can flow smoothly to generate a proper suction force, thereby improving the fly-killing effect. This utility model relates primarily to a design and structure of the anti-fly escape plate and can be used merely as a fly killer.

Fly killers which are of different designs and structures, safe, highly effective and environmentally friendly are still needed in the art. In particular, a lighting device that can be used as a light and also has a fly killing function is extremely needed in the art.

### SUMMARY OF THE INVENTION

It is one objective of non-limiting embodiments of the present disclosure to provide a light having a fly-killing function. The light having a fly-killing function comprises at least one LED chip, a fly storage means, a negative pressure fan, a fan hanger, a ventilation net, and a power supply; wherein the fly storage means is connected to the fan hanger, the LED chip is secured to a lower end surface of the fly storage means, the fly storage means comprises an air inlet and a fly storage groove, the negative pressure fan is mounted onto the fan hanger above the fly storage means, a gap is provided between the blades of the negative pressure fan and an upper end of the fly storage means to allow flies to go through; the ventilation net comprises a plurality of ventilation holes having a size that is able to stop flies from passing therethrough, and the ventilation net is provided circumferentially between the outside wall of the fan hanger and the outside wall of the fly storage means, and the fan hanger, the ventilation net, and the fly storage means form a closed space except for the ventilation holes and the air inlet.

Since flies are phototactic, they will aggregate near the LED chip when the LED chip is powered on and emitting light. Then, flies are sucked into the closed space formed by the fan hanger, the ventilation net, and the fly storage means via the gap provided between the blades of the negative pressure fan and the upper end of the fly storage means by the rotating negative pressure fan when powered on. Due to the act of the negative pressure fan, the flies would not be able to fly outside of the air inlet after they are trapped. Furthermore, since the size of the ventilation holes in the ventilation net can stop the flies from passing therethrough, the flies would not be able to fly outside the closed space, and finally fall into the fly storage groove of the fly storage means, and air dried to death.

Some embodiments of the light having a fly-killing function of the present disclosure may be used just for lighting when the negative pressure fan is not powered on and rotating.

In a particular embodiment, the light having a fly-killing function is provided with a transparent light cover that cooperates with the shape of the lower end of the fly storage means and secured to the lower end of the fly storage means. The light cover comprises a light cover air inlet which is aligned with, and in fluid communication with, the air inlet of the fly storage means. This air inlet is partially formed by a passage through the fly storage means.

In a particular embodiment, the fly storage means and the fan hanger are connected together by insertion, wherein the fan hanger comprises an insertion head extending downward, and the fly storage means comprises an insertion socket capable of being engaged with the insertion head. Alternatively, the fly storage means may comprise an insertion head extending upward, and the fan hanger comprises an insertion socket capable of being engaged with the insertion head.

In a preferred embodiment, a fastening screw is used to secure the insertion head and the insertion socket together.

In another preferred embodiment, the insertion head is a portion of a cylinder having a thickness and a length, and the ventilation net is provided outside of the insertion head abutting against the same, and is rotatable with respect to the insertion head; the ventilation net comprises a window opening for observing and removing flies from the fly storage means, and the window opening is substantially or completely covered by the insertion head when the light having a fly killing function is in the working state.

In yet another preferred embodiment, the insertion head is provided with a hole for power lines supplying power to the LED chip to pass through.

In yet another preferred embodiment, a circuit board for controlling the LED chip and the negative pressure fan is provided above the fan hanger.

In yet another preferred embodiment, an upper shell is further provided, and the upper shell, the circuit board, and the fan hanger are secured together by a fastening screw.

In yet another preferred embodiment, a speed control rod for changing the speed of the negative pressure fan extends from the circuit board to outside of the upper shell to facilitate manual adjustment of the speed of the negative pressure fan.

In yet another preferred embodiment, a light head is provided on the upper shell, and the lamp head comprises a male screw on the outer wall thereof that can be rotated into a light socket for supplying power.

Potential uses of various non-limiting embodiments of the light having a fly-killing function of the present disclosure can be used just for lighting when killing flies is not required. Where fly-killing is required, the negative pressure fan may be put into operation to force flies into the fly storage means causing the flies to be air dried to death in the fly storage groove. Furthermore, the generally closed light of certain embodiments of the present disclosure comprising the light cover, the circuit board, the upper shell, and the light head with male screw can, as a whole, may be detachably mounted into a regular light socket. Therefore, it is safe and easy to install and remove.

### BRIEF DESCRIPTION OF THE DRAWINGS

FIG. 1 is a schematic perspective view of the light having a fly-killing function of an embodiment of the present disclosure;

FIG. 2 is a schematic exploded view of an embodiment of the light having a fly-killing function of FIG. 1;

FIG. 3 is a longitudinal cross-sectional view of an embodiment of the light having a fly-killing function of FIG. 1, wherein the negative pressure fan is not cut;

FIG. 4 is a local cross-sectional view of an embodiment of the light having a fly-killing function of FIG. 1;

FIG. 5 is a bottom view of an embodiment of the light having a fly-killing function of FIG. 1, wherein a portion of the light cover is cut away;

FIG. 6 is a general top view of an embodiment of the light having a fly-killing function of FIG. 1;

FIG. 7 is a general front view of an embodiment of the light having a fly-killing function of FIG. 1, wherein the window opening is uncovered;

FIG. 8 is a general front view of an embodiment of the light having a fly-killing function of FIG. 1, wherein the window opening is covered;

FIG. 9 is another perspective front view of an embodiment of the light having a fly-killing function of FIG. 1, wherein the window opening is uncovered;

FIG. 10 is another perspective front view of an embodiment of the light having a fly-killing function of FIG. 1, wherein the window opening is covered;

FIG. 11 is a direct top view of an embodiment of the light having a fly-killing function of FIG. 1; and

FIG. 12 is a direct bottom view of an embodiment of the light having a fly-killing function of FIG. 1.

### DETAILED DESCRIPTION OF THE INVENTION

Non-limiting embodiments of the present disclosure will be further described by referring to the accompanying drawings. It should be understood that the embodiments illustrated in the drawings are for description of the invention only and shall not be construed as any limitation to the present disclosure. The scope of the invention would rather be defined by the appended claims.

It should be understood that the accompanying drawings are merely used to illustrate embodiments of the present disclosure, and are not necessarily drawn to scale.

It should also be understood that the directional terms such as “above”, “under”, “left”, “right”, “front”, “rear”, “bottom”, or “top”, or the like that may be used herein are merely for the ease of describing embodiments of the present disclosure, and they should not be construed as limitations to the present disclosure in any way.

For brevity, reference numbers are not provided for all the parts, components or features shown in some of the figures. Thus, a cross-reference to all of the drawings should be made when reading the detailed description below to obtain a clear and complete understanding of the present disclosure.

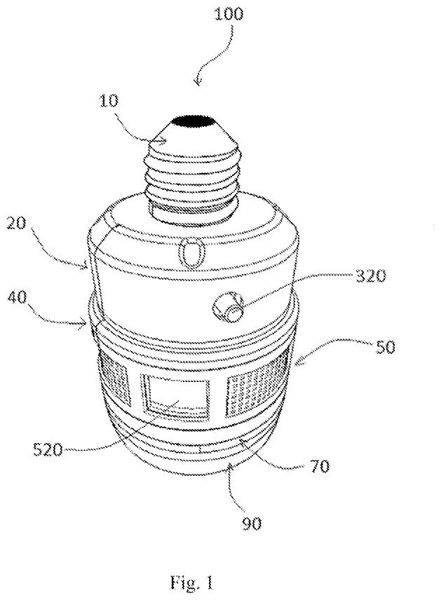

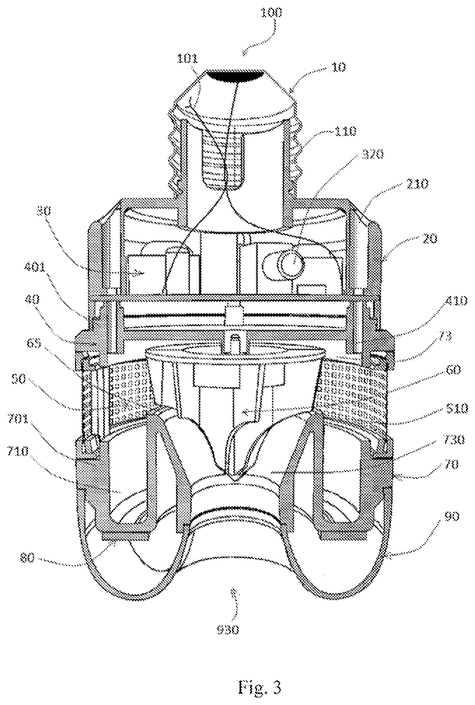

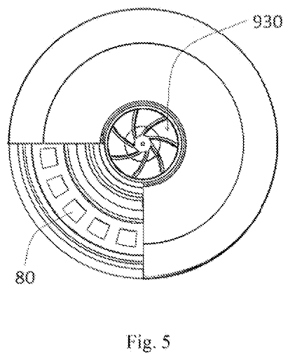

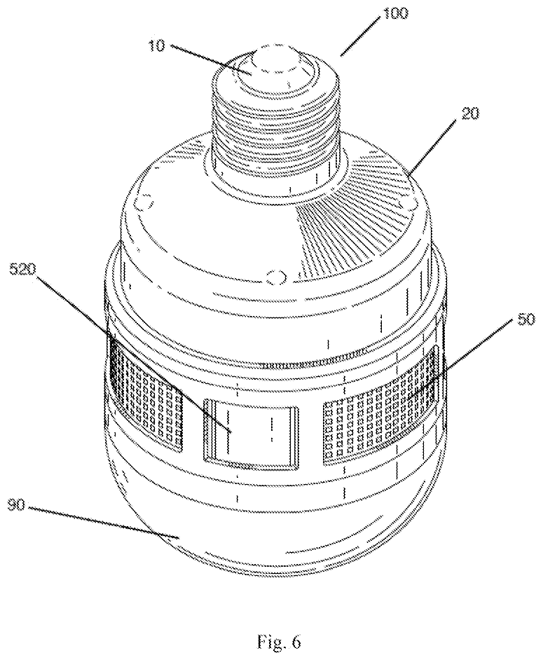

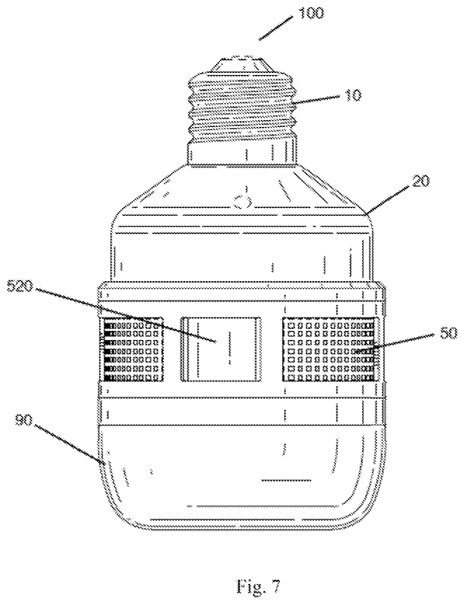

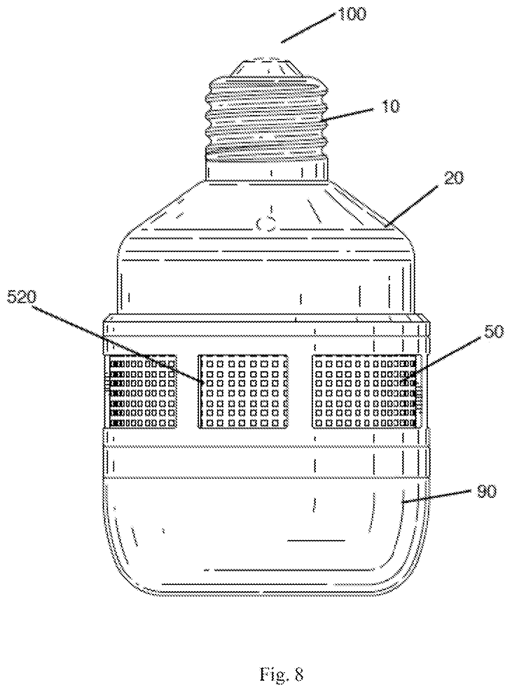

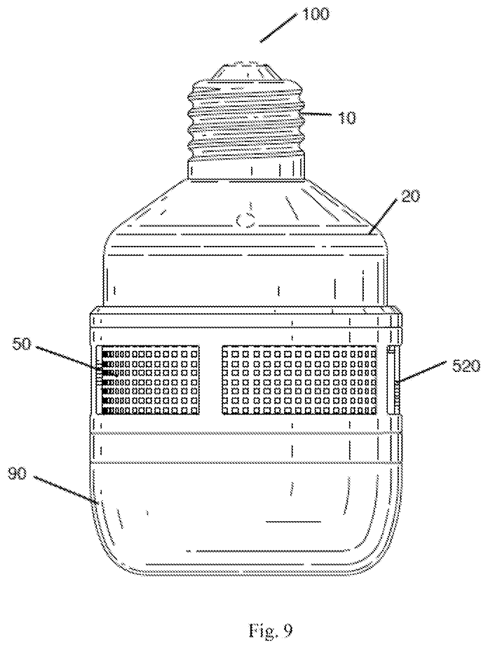

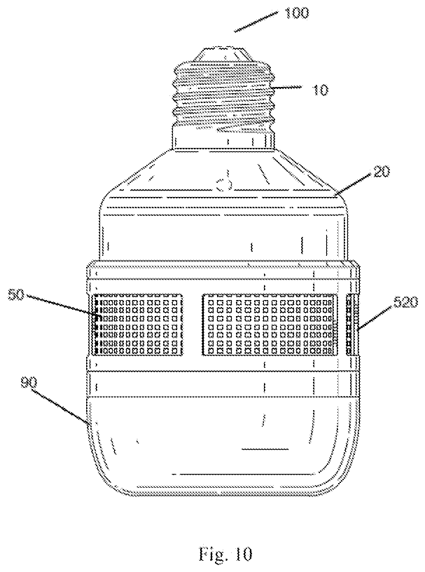

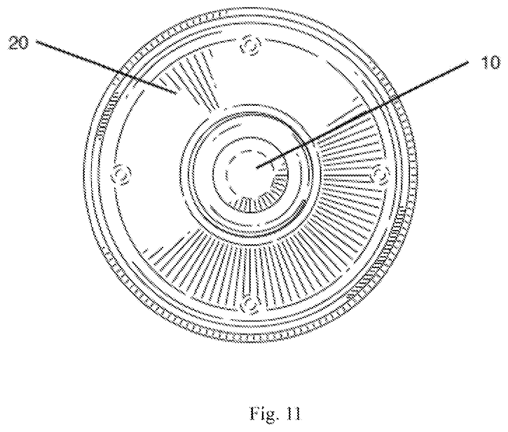

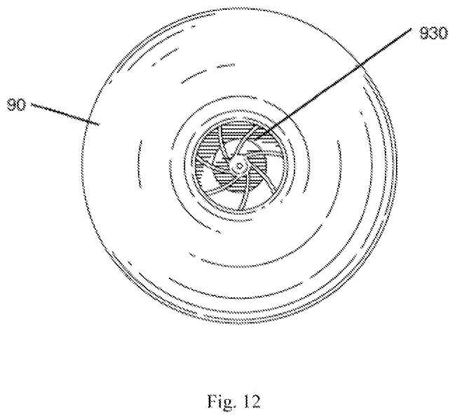

Referring to FIGS. 1-12, a light 100 having fly-killing function of the present disclosure is shown. The basic concept of the invention is to provide a device that can be used as a light and can kill flies. Therefore, although a preferred embodiment of the present disclosure is illustrated in FIGS. 1-12, the present disclosure is not limited thereto. Light 100 may take the general form factor of an illuminant or bulb designed to fit into commonly-available light fixtures, such as those designed to receive an A19, PAR30 or other common residential light fixtures. In order to carry out the basic concept of the present disclosure, the light 100 having a fly-killing function illustrated herein comprises at least a LED chip 80, a fly storage means 70, a negative pressure fan 60, a fan hanger 40, a ventilation net 50, and a power source. The LED chip 80 may be welded to a circuit board (not shown), such as an aluminum circuit board, and then the circuit board is secured to the lower end surface of the fly storage means 70. The LED chip 80 is coupled to the power source via the circuit board. The fly storage means 70 comprises an air inlet 730 and a fly storage groove 710 that is separated from the air inlet 730. The negative pressure fan 60 is mounted to the fan hanger 40 above the air inlet 730, and preferably, is extended a depth into the air inlet 730. A gap 65 that allows flies to pass therethrough is provided between the blades of the negative pressure fan 60 and the upper end 73 of the fly storage means 70. The ventilation net 50 is provided with a plurality of ventilation holes 510 having a size capable of stopping flies from passing therethrough. The ventilation net is provided circumferentially between the outside wall 401 of the fan hanger 40 and the outside wall 701 of the fly storage means 70, with the fly storage means 70 being connected to the fan hanger 40. The fan hanger 40, the ventilation net 50, and the fly storage means 70 form a closed space except the ventilation holes 510 and the air inlet 730.

Since flies are phototactic, once the LED chip is supplied with power and emits light, flies will aggregate around the LED chip 80, and sucked by the powered-on, rotating negative pressure fan 60 into the closed space except the ventilation holes 510 and the air inlet 730 formed by the fan hanger 40, the ventilation net 50, and the fly storage means 70 via the air inlet 730 of the fly storage means and the gap 65 formed between the blades of the negative pressure fan 60 and the upper end 73 of the fly storage means 70. Due to the act of the negative pressure fan 60, the flies would not be able to fly backward out of the air inlet 730. Additionally, since the size of the ventilation holes 510 of the ventilation net 50 is capable of stopping the flies from passing therethrough, the flies would not be able to fly out of the closed space, and finally would fall within the fly storage groove 710 of the fly storage means, and air-dried to death. The dead flies may be collected and maintained in the fly storage groove 710 of the fly storage means as an operation of gravity on the orientation of the light 100.

Preferably, the LED chip 80 is a LED chip that is suitable for illumination and has strong attraction with respect to flies, and the selection of such a LED chip would be readily made by those skilled in the art. Alternative embodiments may be achieved through the use of other lighting sources that are suitable for illumination and have strong attraction with respect to flies.

For achieving uniform luminance, in a preferred embodiment, a plurality of LED chips are provided evenly on the lower ring shaped end surface of the fly storage means 70.

The air inlet 730 is a passage running through the entire fly storage means 70. Preferably, the air inlet is in the shape of a bell, i.e., the air inlet has an increasing cross section at the end approaching the negative pressure fan 60. Additionally, the negative pressure fan 60 and the blades thereof are preferably designed and installed in a way such that the blades extend a depth into the air inlet 730, and the shapes of the blades are fitted with the bell-shaped air inlet 730. This design can obtain a much stronger suction and facilitate trapping of flies in the fly storage means 70 via the air inlet 730 and the gap 65 formed between the blades of the negative pressure fan 60 and the upper end 73 of the fly storage means 70. Operation of the negative pressure fan 60 creates an area of negative pressure in upper end 73 of the fly storage means 70 relative to air inlet 730, which creates the stronger suction and facilitates the trapping of flies.

The ventilation net 50 is provided between the upper end of the side wall 720 of the fly storage means 70 and the lower end of the side wall 401 of the fan hanger 40. Particular ways of achieving this arrangement can be readily selected by those skilled in the art, and details for such particular ways will not be described herein for brevity.

The ventilation net 50 is provided with a plurality of ventilation holes for discharging the air sucked by the negative pressure fan 60 out of the light having a fly-killing function of the present disclosure. The ventilation holes 510 are preferably provided evenly in the entire ventilation net 50 so that the air can be discharged evenly, thereby reducing the noise. The size of the ventilation holes 510 should ensure that the flies trapped in the closed space would not be able to pass therethrough and escape. In a preferred embodiment, the ventilation holes 510 may be in the shape of a bell with the cross section thereof becoming increasingly larger from inside to outside, thereby further facilitating discharge of the air and reducing the noise of the air flow.

In a particular embodiment, the light 100 having a fly-killing function of the present disclosure further comprises a transparent light cover 90 having a shape matching with the shape of the lower end of the fly storage means 70, and the transparent light cover 90 is secured to lower end of the fly storage means 70. The transparent light cover 90 includes a light cover air inlet 930 that is in fluid communication with the air inlet 730 of the fly storage means 70. The transparent light cover 90 may be secured, such as by an adhesive, to the lower end of the fly storage means 70. In an embodiment, air will generally flow from the light cover air inlet 930, through the air inlet 730, into the upper end 73 of the fly storage means 70 and out through the ventilation holes 510 of ventilation net 50.

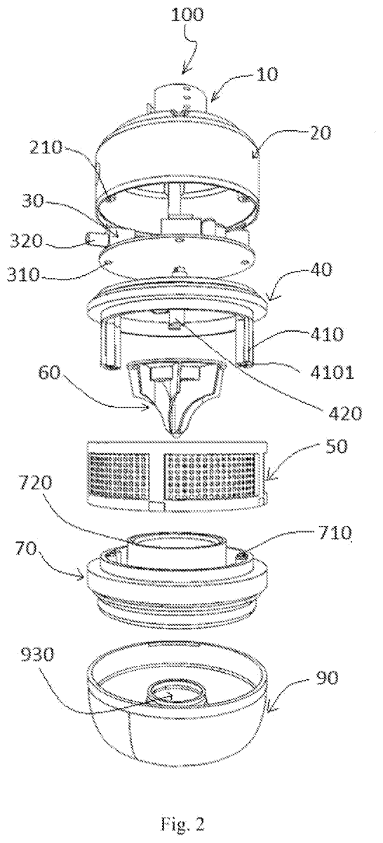

Referring to FIG. 2, in a particular embodiment, the fly storage means 70 is connected with the fan hanger 40 by means of insertion, with the fan hanger including an insertion head 410 extending downward, and the fly storage means 70 including a socket 710 which engages with the insertion head 410. Of course, alternatively, the fly storage means 70 may include an insertion head extending upward, and the fan hanger 40 includes a socket which engages with the insertion head. Furthermore, the insertion head may be provided with a screw hole (not shown), and a fastening screw can be used to fasten the insertion head and the socket together.

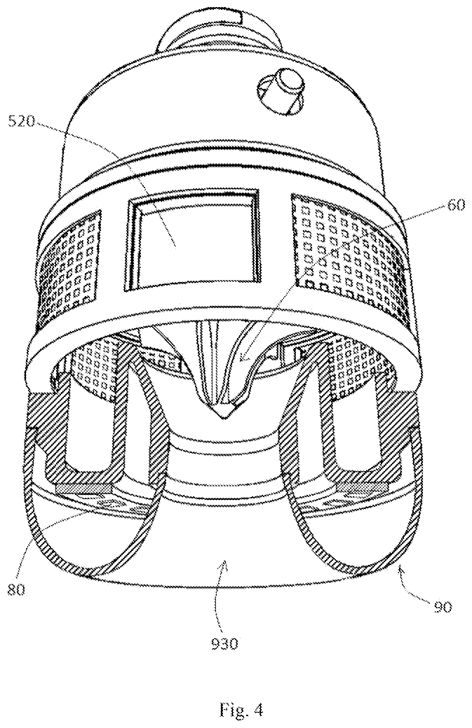

Preferably, the insertion head 410 is a portion of a cylinder having a thickness and a length, and the ventilation net 50 is installed abutting against the external side of the insertion head 410 and can rotate with respect to the same. The ventilation net 50 comprises a window opening 520 (see FIG. 4), which will be covered completely by the insertion head 40 when the light 100 having a fly-killing function is in the working state, so as to form a closed space. When the light 100 having a fly-killing function is in the non-working state, the ventilation net 50 may be rotated so that the window opening 520 goes away from the insertion head 410 so that the interior of the light 100 having a fly-killing function is viewable through the window opening 520, and if required, the flies trapped and air-dried in the fly storage groove 710 may be removed via the window opening 520.

In a preferred embodiment, the insertion head 410 is provided with a through hole 410 for power lines (not shown) supplying power to the LED chips to pass through.

In a preferred embodiment, a circuit board 30 for controlling the LED chips and the negative pressure fan may be further provided above the fan hanger 40. The circuit board 30 may be designed and manufactured as required, and the design and manufacture of the same are known, or at least readily achieved by those skilled in the art.

Accordingly, a preferred embodiment of the light 100 having a fly-killing function of the present disclosure further comprises an upper shell 20. The upper shell 20, the circuit board 30, and the fan hanger 40 may be provided respectively with screw holes 210, 310, and 410 that a fastening screw (not shown) may be driven therethrough to fasten them together.

Preferably, the negative pressure fan 60 may be configured to be speed variable through the circuit board 30, such as a negative pressure fan speed adjusting rod 320 may be provided on the circuit board 30 and extends outside of the upper shell 20 from the circuit board 30 to facilitate manual adjustment of the speed of the negative pressure fan 60. Circuit board 30 may also comprise multiple parts, including a connecting disc (shown as circuit board 30) providing structural support between the upper shell 20 and the fan hanger 40 to the light 100 having a fly-killing function, with a circuit board attached to a surface of the connecting disc.

Preferably, a light head 10 is provided at the top of the upper shell 20. The light head 10 may comprise a male screw 110 on the outside wall thereof which can be rotated into a socket (not shown) for supplying power. This case is similar to the conventional connection of a bulb with a bulb socket, and thus it will not be described in detail. The power lines 101 are coupled to the circuit board 30 so as to supply power thereto.

Various parts or components of the light having a fly killing function of the present disclosure may be formed of any suitable materials, such as for example, the circuit board, the fan hanger and the ventilation net may be formed of nylon or another material, the negative pressure fan may be formed of polybutylene tertephehalate (PBT) or another material, and the fly storage means may be formed of an aluminum oxide ceramic or another material. Any embodiment of the present disclosure is not limited to such materials.

Previous inventions have not considered the many potential novel aspects and advantages that are included in embodiments herein. For instance, one potential advantage demonstrated in some non-limiting embodiments of the present disclosure may be that the light serves a dual function of conventional lighting and attracting and trapping insects. This eliminates the need of having a potentially human-harming ultraviolet insect attractant. Another potential advantage of certain embodiments of the invention may be the air inlet that is partially formed by a passage through the fly storage means. Yet another potential advantage demonstrated by some of the non-limiting embodiments of the invention is its relatively small size in comparison to other trapping devices and, as a non-limiting example, its ability to fit into similar spaces as a conventional light bulb.

Although the shape of embodiments of the light having a fly-killing function is illustrated as generally cylindrical, it is not intended to be limited thereto. The light having a fly-killing function of the present disclosure may also be in the shape of an elliptic cylinder, a square column, or any other polygon column.

It should be understood that the embodiments described above are not intended to limit the scope of the present disclosure, but rather are exemplary embodiments for implementing the present disclosure.

Having described the preferred embodiments of the invention, it is understood that the invention defined by the appended claims is not to be limited by particular details set forth in the above description, as many apparent variations thereof are possible without departing from the spirit or scope thereof

What is claimed is:

1. An illuminant comprising: a light head, a lighting source, a fly storage means, a negative pressure fan, a fan hanger, and a ventilation net; wherein the fly storage means is connected to the fan hanger, the lighting source is secured to a lower end of the fly storage means, the fly storage means comprises an air inlet and a fly storage groove, the negative pressure fan is mounted onto the fan hanger above the fly storage means, a gap is provided between blades of the negative pressure fan and an upper end of the fly storage means to allow flies to go through; the ventilation net comprises a plurality of ventilation holes having a size that is able to stop flies from passing therethrough, and the ventilation net is provided circumferentially between an outside wall of the fan hanger and an outside wall of the fly storage means, and the fan hanger, the ventilation net, and the fly storage means form a closed space except for the ventilation holes and the air inlet.

2. The illuminant according to claim 1, wherein the illuminant further comprises an upper shell and connecting disc, the connecting disc attaches between an upper surface of the fan hanger and a lower surface of the upper shell.

3. The illuminant according to claim 2, wherein the light head comprises a male screw on an outer wall thereof that can be rotated into a light socket for supplying power to the illuminant.

4. The illuminant according to claim 1, wherein the air inlet is partially formed by a passage through the fly storage means.

5. The illuminant according to claim 4, wherein the illuminant further comprises a fly storage groove, whereby the fly storage groove circumscribes the air inlet.

6. The illuminant according to claim 5, wherein the illuminant further comprises a light cover that cooperates with a shape of a lower end of the fly storage means and is secured to the lower end of the fly storage means, and the light cover comprises a light cover air inlet which is aligned with, and in fluid communication with, the air inlet of the fly storage means.

7. The illuminant according to claim 6, wherein the operation of negative pressure fan is configured to provide an airflow from the outside of the illuminant, through the light cover air inlet, through the air inlet of the fly storage means, into the upper end of the fly storage means and then through the ventilation net.

8. The illuminant according to claim 1, wherein the negative pressure fan is configured to create an area of lower air pressure in the upper end of the fly storage means relative to the air pressure of the air inlet.

9. The illuminant according to claim 1, wherein the fly storage means and the fan hanger are connected together by means of insertion, wherein the fan hanger comprises an insertion head extending downward, and the fly storage means comprises an insertion socket capable of being engaged with an insertion head.

10. The illuminant according to claim 9, wherein the insertion head is a portion of a cylinder having a thickness and a length, and the ventilation net is installed outside of the insertion head abutting against the same, and is rotatable with respect to the insertion head; the ventilation net comprises a window opening, and the window opening along the circumferential edge of the insertion head and is completely covered by the insertion head when the fly killing light is in a working state.

11. The illuminant according to claim 10, wherein a circuit board for controlling the negative pressure fan is provided above the fan hanger.

12. The illuminant according to claim 11, wherein the circuit board attaches between an upper surface of the fan hanger and a lower surface of the upper shell.

13. The illuminant according to claim 12, wherein the light head comprises a male screw on an outer wall thereof that can be rotated into a light socket for supplying power to the illuminant.

14. A light having a fly killing function, comprising:
a male coupler head; a tight head, a light source secured to a lower end of a fly storage compartment; the fly storage compartment comprises an air inlet and a fly storage groove; the fly storage compartment connected to a fan hanger; a negative pressure fan mounted onto the fan hanger above the fly storage compartment; and a cylindrical ventilation net comprising a plurality of ventilation holes, the net set between an outside wall of the fan hanger and an outside wall of the fly storage compartment, wherein a gap is provided between the negative pressure fan and an upper end of the fly storage compartment.

15. The light having a fly killing function, according to claim 14, wherein the air inlet is formed by a passage through the fly storage groove.

16. The light having a fly killing function, according to claim 14, wherein said male coupler head is rotatable about an axis, and the ventilation net is rotatable around the axis, the ventilation net further comprising a window opening along the circumferential edge of the male coupler head.

17. A light having a fly killing function, comprising:
a light source secured to a lower end of a fly storage compartment; the fly storage compartment comprises an air inlet and a fly storage groove; the fly storage compartment connected to a fan hanger; a negative pressure fan mounted onto the fan hanger above the fly storage compartment; a cylindrical ventilation net comprising a plurality of ventilation holes, the net set between an outside wall of the fan hanger and an outside wall of the fly storage compartment; and a transparent light cover comprising a central aperture coupled and in fluid communication with said air inlet;
wherein a gap is provided between the negative pressure fan and an upper end of the fly storage compartment; and
wherein the air inlet is partially formed by a passage through the fly storage means.

18. The light according to claim 17 wherein said air inlet is bell-shaped with an increasing cross section at the upper end of the fly storage compartment approaching the negative pressure fan.

19. The light according to claim 18 wherein said fan comprises blades extending into said air inlet.

20. The light according to claim 19 further comprising a male coupler head along an upper end of said light.
